(19) United States
(12) Patent Application Publication
(10) Pub. No.: US 2004/0214580 A1
(43) Pub. Date: Oct. 28, 2004

(54) Wireless network apparatus and method for the wireless network apparatus to transmit data

(76) Inventors: Pi-Cheng Chen, Hsinchu City (TW); Sheng-Yuan Cheng, Jhubei City (TW)

Correspondence Address: SEYFARTH SHAW, 55 EAST MONROE STREET, SUITE 4200, CHICAGO, IL, 60603-5803, US

(21) Appl. No.: 10/654,291

(22) Filed: Sep. 2, 2003

(30) Foreign Application Priority Data
Apr. 24, 2003 (TW) 092109857

(51) Int. Cl. H04Q 7/20

(52) U.S. Cl. 455/452.1; 455/450

(57) ABSTRACT

The wireless network apparatus is electrically connected to a CPU, and comprises a hard-wired computing module and a transmitting module. The CPU executes a driver software to compute a first PLCP length for a first transmission rate, while the wireless network apparatus converts the first PLCP length into a second PLCP length for a second transmission rate through one shift operation and one increment (or decrement) operation executed by the hard-wired computing module. According to the present invention method for transmitting data, the first PLCP length of the first transmission rate is computed first, and the data is then transmitted at the first transmission rate. If the transmission at the first transmission rate fails, the hard-wired computing module will compute the second PLCP length for the second transmission rate based on the first PLCP length, and then the data is transmitted again at the second transmission rate.

### BACKGROUND OF THE INVENTION

(A) Field of the Invention

The present invention relates to a wireless network apparatus and a method for the wireless network apparatus to transmit data, and more particularly, to a wireless network apparatus that uses hard-wired logic circuits to compute a Physical Layer Convergence Protocol (PLCP) length and a method for the wireless network apparatus to transmit data.

(B) Description of the Related Art

FIG. 1 is a schematic diagram showing a method for transmitting data according to the prior art. As shown in FIG. 1, a first station 10 communicates with one or more second station 20 in a wireless manner. The first station 10 comprises a CPU 12, a media access control device 14 and a physical layer device (transmitting device) 16, while the second station 20 also contains a CPU 22, a media access control device 24 and a physical layer device (receiving device) 26.

When the first station 10 is ready to transmit a Service Data Unit (SDU) to the second station 20, the CPU 12 of the first station 10 will execute a driver software 18 to compute a PLCP length for a certain transmission rate, such as the PLCP length L₁₁ for 11 Mbit/sec, and its length extension bit.

Then, the media access control device 14 appends a header containing the PLCP length and its length extension bit to the SDU to form a frame, which will be transmitted to the second station 20 via the transmission device 16 at the transmission rate of 11 Mbit/sec. The media access control device 24 of the second station 20 uses the receiving device 26 to receive the frame, which is then forwarded to the CPU 22 as the SDU. The CPU 22 will execute a driver software 28 to restore the received SDU into the original data according to the PLCP length and the length extension bit.

According to the IEEE 802.11b standard, the first station 10 can transmit the frame at four different transmission rates, i.e., 11, 5.5, 2 and 1 Mbit/sec, respectively. The PLCP length is defined as the time in microseconds for transmitting the SDU, and the following are formulas for computing the PLCP length of each transmission rate:

1 Mbit/sec: byte number×8;

2 Mbit/sec: byte number×4;

5.5 Mbit/sec: byte number×(8/5.5);

11 Mbit/sec: byte number×(8/11);

To compute the PLCP lengths at the transmission rate of 11 and 5.5 Mbit/sec, division operations are required. According to the prior art, the CPU 12 of the first station 10 first executes the driver software 18 to compute a PLCP length for a certain transmission rate, and then the media access control device 14 can transmit the frame at this transmission rate. Under this condition, the media access control device 14 only has the PLCP length for this transmission rate; therefore it continues to transmit the frame again at the same transmission rate if the transmission fails.

The above-mentioned method for transmitting data can only transmit frames at the same transmission rate, whose transmission performance is very poor and the frame is easy to become lost. To transmit the frame again at different transmission rates, it needs to compute a second PLCP length for a second transmission rate through many very complicated operations, such as division operations. In view of the above-mentioned issues, the present invention provides a method for transmitting frames at different transmission rates, wherein the second PLCP length for the second transmission rates is computed by a simple logic operation and the frame is transmitted again at a the second transmission rate to increase the possibility of the successful transmission.

### SUMMARY OF THE INVENTION

The objective of the present invention is to provide a wireless network apparatus and a method for the wireless network apparatus to transmit data, by which frames can be transmitted at different transmission rates and the probability of successful transmission can be increased.

In order to achieve the above-mentioned objective, and avoid the problems of the prior art, the present invention provides a wireless network apparatus and a method for the wireless network apparatus to transmit data. The wireless network apparatus of the present invention is electrically connected to a CPU, and comprises a hard-wired computing module and a transmitting module. The CPU executes a driver software to compute a first PLCP length for a first transmission rate, while the wireless network apparatus converts the first PLCP length for the first transmission rate into a second PLCP length for a second transmission rate through one shift operation and one increment (or decrement) operation executed by the hard-wired computing module.

According to the method for transmitting data of the present invention, the first PLCP length of the first transmission rate is computed first of all, and the data is then transmitted at the first transmission rate. If the transmission at the first transmission rate fails, the hard-wired computing module of the wireless network apparatus will compute the second PLCP length for the second transmission rate based on the first PLCP length through one shift operation and one increment (or decrement) operation, and then the data is transmitted again at the second transmission rate. Consequently, different transmission rates can be used to transmit frames if the data transmission fails, and the transmission performance can be increased.

Compared with the prior art, the present invention possesses the following advantages:

1. The CPU is used to compute the first PLCP length for a first transmission rate, and the wireless network apparatus can compute a second PLCP length for a second transmission rate different from the first transmission rate. Since the CPU only has to compute one PLCP length, the load is decreased and the performance is therefore improved.

2. The hard-wired computing module uses one shift operation and one increment (or decrement) operation to convert the first PLCP length into the second PLCP length. The wireless network apparatus can compute the PLCP length for the transmission rate of 11 Mbit/sec or 5.5 Mbit/sec using a simple logic operation, thus the hardware cost is greatly reduced.

3. After the hard-wired computing module computes the PLCP lengths for other transmission rates, the data can be transmitted at different transmission rates, thus the transmission performance is increased.

### BRIEF DESCRIPTION OF THE DRAWINGS

Other objectives and advantages of the present invention will become apparent upon reading the following description and upon reference to the accompanying drawings in which:

FIG. 1 is a schematic diagram showing the method for transmitting data according to the prior art;

FIG. 2 is a schematic diagram of a wireless network apparatus according to the first embodiment of the present invention;

FIG. 3 is a schematic diagram of a wireless network apparatus according to the second embodiment of the present invention; and

FIG. 4 is a flow chart showing the data transmitting procedure of the wireless network apparatus according to the present invention.

### DETAILED DESCRIPTION OF THE INVENTION

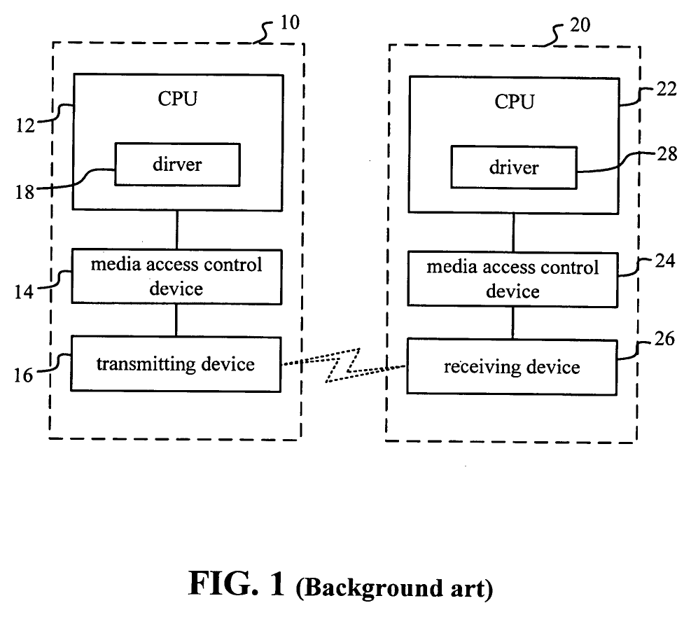

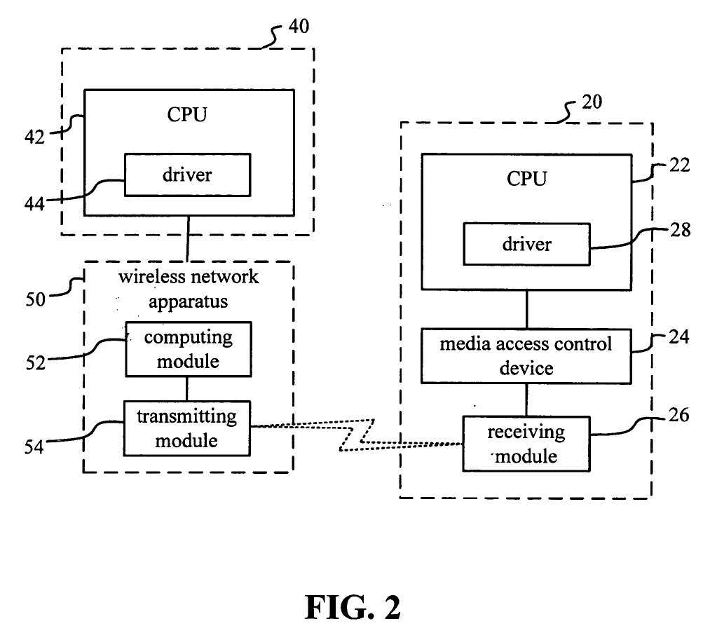

FIG. 2 is a schematic diagram of a wireless network apparatus 50 according to the first embodiment of the present invention. As shown in FIG. 2, the wireless network apparatus 50 is installed in a first station 40, wherein the first station 40 comprises a CPU 42 and exchanges data with the second station 20 through the wireless network apparatus 50. The second station 20 is the same as that described in FIG. 1, in other words, the present invention can be applied to the existing wireless network environment without changing the hardware at the receiving terminal.

The wireless network apparatus 50 can be a wireless network card, which comprises a hard-wired computing module 52 and a transmitting module 54. The CPU 42 of the first station 40 can execute a driver software 44 to execute at least one division operation for generating a first PLCP length for a first transmission rate, while the hard-wired computing module 52 can execute one shift operation and one increment (or decrement) operation to convert the first PLCP length for the first transmission rate into a second PLCP length for a second transmission rate. The first transmission rate is 11 Mbit/sec and the second transmission rate is 5.5 Mbit/sec, or the first transmission rate is 5.5 Mbit/sec and the second transmission rate is 11 Mbit/sec.

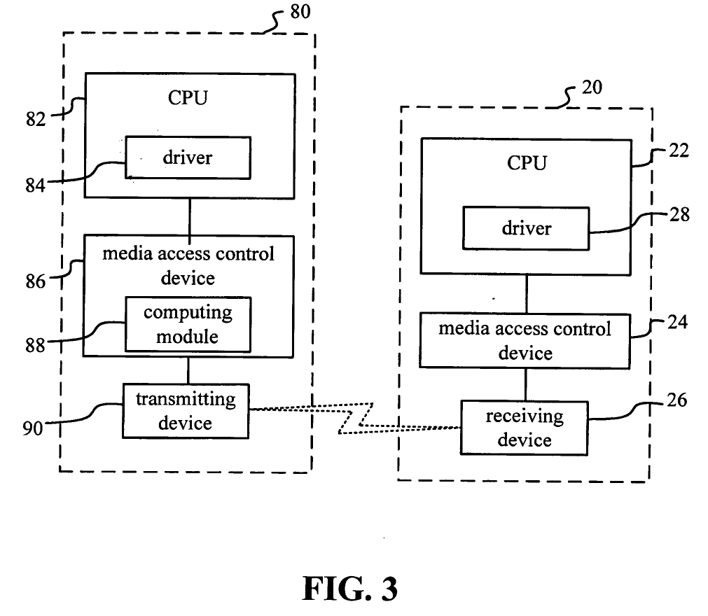

FIG. 3 is a schematic diagram of a wireless network apparatus 80 according to the second embodiment of the present invention. As shown in FIG. 3, the wireless network apparatus 80, such as a bridge, comprises a CPU 82, a media access control device 86 and a transmitting device 90. The media access control device 86 comprises a hard-wired computing module 88. The CPU 82 can execute a driver software 84 to execute at least one division operation for generating a first PLCP length for a first transmission rate, while the hard-wired computing module 88 can execute one shift operation and one increment (or decrement) operation to convert the first PLCP length for the first transmission rate into a second PLCP length for a second transmission rate. The first transmission rate is 11 Mbit/sec and the second transmission rate is 5.5 Mbit/sec, or the first transmission rate is 5.5 Mbit/sec and the second transmission rate is 11 Mbit/sec.

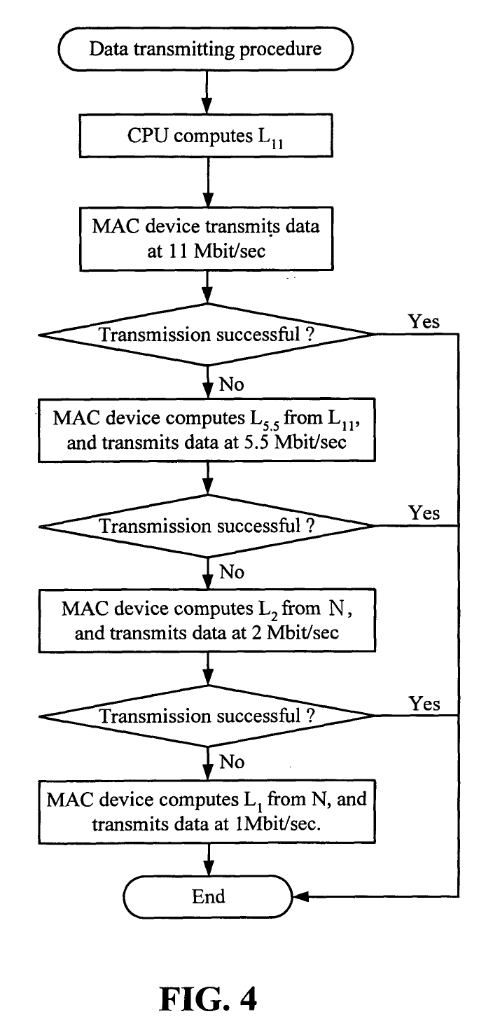

FIG. 4 is a flow chart showing the data transmitting procedure of the wireless network apparatus 40 according to the present invention. Please refer to FIG. 2; when the first station 40 is ready to transmit an SDU to the second station 20, the CPU 42 executes the driver software 44 to compute the PLCP length (L₄₁) and the flag value (FLAG) for the transmission rate of 11 Mbit/sec according to formula (1), and forwards the L₁₁, the byte number (N), the FLAG and the length extension bit of the L₁₁ to the wireless network apparatus 50.

$$\begin{matrix}\{ \begin{matrix}{L}_{11}^{′} = N \times \frac{8}{11} \\ {L}_{11} = Ceiling ( {L}_{11}^{′} ) = {L}_{11}^{′} + A , 0 \leq A < 1 , \\ Ceiling ( {L}_{11}^{′} ) represents the next carry integer value of {L}_{11}^{′} \\ IF A < 0.5 , then FLAG = 0 , else FLAG = 1 \end{matrix} & ( 1 )\end{matrix}$$

The driver software 44 computes a first value (L′₁₁) from the byte number (N) of the SDU through division operations, the next carry integer of the L′₁₁, and the difference (A) between the L′₁₁ and the L₁₁. The next carry integer of the L′₁₁ is the PLCP length Low for the transmission rate of 11 Mbit/sec. The flag value (FLAG) is set to be zero if the difference (A) is less than 0.5, and to be one otherwise.

After the CPU 42 computes the PLCP length L₁₁ and the length extension bit for the PLCP length L₁₁, the wireless network apparatus 50 appends a header containing the PLCP length L₁₁ and the length extension bit to the SDU to form a frame, which is then transmitted by the transmitting module 54 to the second station 20 at the transmission rate of 11 Mbit/sec. The media access control device 24 of the second station 20 receives the frame with the receiving module 26, and forwards it to CPU 22. The CPU 22 executes the driver software 28, and restores the SDU to the original data according to the PLCP length L₁₁ and the length extension bit.

If the transmission of the frame fails at the transmission rate of 11 Mbit/sec, the wireless network apparatus 50 will use the hard-wired computing module 52 to compute the PLCP length L_{5.5} for the transmission rate of 5.5 Mbit/sec based on the PLCP length L₁₁ for the transmission rate of 11 Mbit/sec. Formula (2) shows the computation of the PLCP length L_{5.5} based on the PLCP length L₁₁:

$$\{ \begin{matrix}2 {L}_{11} = 2 {L}_{11}^{′} + 2 A \\ {L}_{5.5}^{′} = N \times \frac{8}{5.5} = 2 {L}_{11}^{′} \\ {L}_{5.5} Ceiling ( {L}_{5.5}^{′} ) = C eiling ( 2 {L}_{11}^{′} ) = Ceiling ( 2 {L}_{11} 2 A ) 0 \leq 2 A < 2 \end{matrix} \qquad ( 2 )$$

The wireless network apparatus 50 first checks the flag value (FLAG) when computing the L_{5.5} from the L₁₁. If the flag value is zero, the L_{5.5} can be obtained by left shifting one bit of the L₁₁, i.e., multiplying the L ₁₁ by 2. If the flag value is one, the L_{5.5} can be obtained by left shifting one bit of the L₁₁ and then subtracting one (decrement operation). The following table illustrates the correspondence for computing the L_{5.5} from the L₁₁:

| A | 0 | 0˜0.5 | 0.5 | >0.5 |
|---|---|---|---|---|
| 2A | 0 | 0.x | 1 | 1.x |
| L_{5.5} | 2L₁₁ | 2L₁₁ | 2L₁₁ − 1 | 2L₁₁ − 1 |

After computing the L_{5.5}, the wireless network apparatus 50 uses the L_{5.5} to update the content of the PLCP length field in the frame, and uses the transmitting module 54 to transmit the updated frame again to the second station 20 at the transmission rate of 5.5 Mbit/sec.

If the transmission of the frame still fails at the transmission rate of 5.5 Mbit/sec, the hard-wired computing module 52 of the wireless network apparatus 50 computes the PLCP length L₂ for the transmission rate of 2 Mbit/sec based on the byte number N of the SDU. The hard-wired computing module 52 computes the L₂ by left shifting two bits of the byte number N, i.e., multiplying the byte number N by 4. After computing the L₂, the wireless network apparatus 50 uses the L₂ to update the content of the PLCP length field in the frame, and transmit the updated frame again to the second station 20 at the transmission rate of 2 Mbit/sec.

If the transmission of the frame fails at the transmission rate of 2 Mbit/sec again, the hard-wired computing module 52 of the wireless network apparatus 50 computes the PLCP length L₁ for the transmission rate of 1 Mbit/sec based on the byte number N of the SDU. The hard-wired computing module 52 computes the L₁ by left shifting three bits of the byte number N, i.e., multiplying the byte number N by 8. After computing the L₁, the wireless network apparatus 50 uses the L₁ to update the content of the PLCP length field in the frame, and transmits the frame to the second station 20 at the transmission rate of 1 Mbit/sec. The above-mentioned procedure is not confined by the sequences, for example, the frame can be transmitted again at the transmission rate of 2 Mbit/sec or 1 Mbit/sec after the transmission fails at the transmission rate of 11 Mbit/sec.

The CPU 42 can compute the PLCP length (L_{5.5}) for the transmission rate of 5.5 Mbit/sec first, while the wireless network apparatus 50 can then compute the PLCP length (L₁₁) for the transmission rate of 11 Mbit/sec. Formula (3) shows the computation of the PLCP length:

$$\{ \begin{matrix}{L}_{5.5} = Ceiling ( {L}_{5.5}^{′} ) \\ {L}_{11} = Ceiling ( \frac{{L}_{5.5}^{′}}{2} )\end{matrix} \qquad ( 3 )$$

After the CPU 42 computes the L_{5.5}, the hard-wired computing module 52 of the wireless network apparatus 50 can compute the L₁₁ by right shifting one bit of the L_{5.5}, i.e., dividing the L_{5.5} by 2, and adding (increment operation) the least significant bit (LSB) of the L_{5.5}. The following table illustrates the correspondence for computing the L₁₁ based on the L_{5.5}:

| L_{5.5} = N × 8/5.5 = A + B + C | | | | |
|---|---|---|---|---|
| A | B | C | L_{5.5} = Ceiling(L_{5.5}) | ${L}_{11} = Ceiling ( \frac{{L}_{5.5}}{2} )$ |
| Even | 0 | C = 0 | A (Even number) | A/2 |
| Even | 1 | C = 0 | A + 1 (Odd number) | Ceiling(A/2 + 1/2) = A/2 + 1 |
| Even | 0 | 0 < C < 1 | A + 1 (Odd number) | Ceiling(A/2 + C/2) = A/2 + 1 |
| Even | 1 | 0 < C < 1 | A + 2 (Even number) | Ceiling(A/2 + (1 + C)/2) = A/2 + 1 |

Compared with the prior art, the present invention possesses the following advantages:

1. The CPU is used to compute the first PLCP length for a first transmission rate, and the wireless network apparatus can compute a second PLCP length for a second transmission rate different from the first transmission rate. Since the CPU only has to compute one PLCP length, the load is decreased and the performance is therefore improved.

2. The hard-wired computing module converts the first PLCP length into the second PLCP length through one shift operation and one increment (or decrement) operation. The wireless network apparatus can compute the PLCP length for the transmission rate of 11 Mbit/sec or 5.5 Mbit/sec using a simple logic operation, thus the hardware cost is greatly reduced.

3. After the hard-wired computing module computes the PLCP lengths for other transmission rates, the data can be transmitted at different transmission rates, thus the transmission performance is increased.

The above-described embodiments of the present invention are intended to be illustrative only. Numerous alternative embodiments may be devised by those skilled in the art without departing from the scope of the following claims.

What is claimed is:

1. A wireless network apparatus, comprising a hard-wired computing module for converting a first physical layer convergence protocol (PLCP) length for a first transmission rate into a second PLCP length for a second transmission rate.

2. The wireless network apparatus of claim 1, adapted to be installed in a station with a CPU, wherein the CPU uses a driver software to execute at least one division operation for generating the first PLCP length for the first transmission rate, while the hard-wired computing module executes one shift operation and one decrement operation for converting the first PLCP length into the second PLCP length.

3. The wireless network apparatus of claim 2, wherein the first transmission rate is 11 Mbit/sec, the second transmission rate is 5.5 Mbit/sec, and the CPU executes the driver software to compute a length extension bit for the transmission rate of 11 Mbit/sec.

4. The wireless network apparatus of claim 1, adapted to be installed in a station with a CPU, wherein the CPU uses a driver software to execute a at least one division operation for generating the first PLCP length for the first transmission rate, while the hard-wired computing module executes one shift operation and one increment operation for converting the first PLCP length into the second PLCP length.

5. The wireless network apparatus of claim 4, wherein the first transmission rate is 5.5 Mbit/sec, the second transmission rate is 11 Mbit/sec, and the CPU executes the driver software to compute a length extension bit for the transmission rate of 11 Mbit/sec.

6. A wireless network apparatus, comprising:
a CPU executing a driver software for computing a first PLCP length for a first transmission rate;
a media access controller including a hard-wired computing module for converting the first PLCP length for the first transmission rate into a second PLCP length for a second transmission rate; and
a transmitting device electrically connected to the media access controller.

7. The wireless network apparatus of claim 6, wherein the hard-wired computing module executes one shift operation and one decrement operation to convert the first PLCP length for the first transmission rate into the second PLCP length for the second transmission rate.

8. The wireless network apparatus of claim 7, wherein the first transmission rate is 11 Mbit/sec, the second transmission rate is 5.5 Mbit/sec, and the CPU executes the driver software to compute a length extension bit for the transmission rate of 11 Mbit/sec.

9. The wireless network apparatus of claim 6, wherein the hard-wired computing module executes one shift operation and one increment operation to convert the first PLCP length for the first transmission rate into the second PLCP length for the second transmission rate.

10. The wireless network apparatus of claim 9, wherein the first transmission rate is 5.5 Mbit/sec, the second transmission rate is 11 Mbit/sec, and the CPU executes the driver software to compute a length extension bit for the transmission rate of 11 Mbit/sec.

11. A method for a wireless network apparatus to transmit data, comprising the steps of:
computing a first PLCP length for a first transmission rate;
transmitting data at the first transmission rate;
computing a second PLCP length for a second transmission rate based on the first PLCP length if the transmission fails; and
transmitting data at the second transmission rate.

12. The method for a wireless network apparatus to transmit data of claim 11, wherein the first PLCP length for the first transmission rate is computed by at least one division operation, while the second PLCP length for the second transmission rate is computed by one shift operation and one decrement operation.

13. The method for a wireless network apparatus to transmit data of claim 12, further comprising the step of:
computing a length extension bit for a transmission rate of 11 Mbit/sec, wherein the first transmission rate is 11 Mbit/sec, and the second transmission rate is 5.5 Mbit/sec.

14. The method for a wireless network apparatus to transmit data of claim 11, wherein the first PLCP length for the first transmission rate is computed by at least one division operation, while the second PLCP length for the second transmission rate is computed by one shift operation and one increment operation.

15. The method for a wireless network apparatus to transmit data of claim 14, further comprising the step of:
computing a length extension bit for a transmission rate of 11 Mbit/sec, wherein the first transmission rate is 5.5 Mbit/sec, and the second transmission rate is 11 Mbit/sec.

16. The method for a wireless network apparatus to transmit data of claim 11, wherein computing the first PLCP length for the first transmission rate comprises the steps of:
multiplying the byte number of the data to be transmitted by 8 and dividing by 11 for generating a first value;
computing the first PLCP length, which is equal to a next carry integer of the first value;
computing the difference between the first value and the next carry integer; and
setting a flag to be zero if the difference is smaller than 0.5, and to be one otherwise.

17. The method for a wireless network apparatus to transmit data of claim 16, wherein computing the second PLCP length for the second transmission rate comprises the step of:
left shifting one bit of the first PLCP length if the flag is zero, and left shifting one bit of the first PLCP length and then subtracting one otherwise.

18. The method for a wireless network apparatus to transmit data is of claim 11, wherein computing the first PLCP length for the first transmission rate comprises the steps of:
multiplying the byte number of the data to be transmitted by 8 and dividing by 5.5 for generating a second value; and
computing the first PLCP length, which is equal to a next carry integer of the second value.

19. The method for a wireless network apparatus to transmit data of claim 18, wherein computing the second PLCP length for the second transmission rate comprises the steps of:
right shifting one bit of the first PLCP length; and
adding the least significant bit of the first PLCP length.

20. The method for a wireless network apparatus to transmit data of claim 11, wherein the second transmission rate is 2 Mbit/sec, and the second PLCP length is computed by left shifting two bits of the byte number of the data to be transmitted.

21. The method for a wireless network apparatus to transmit data of claim 11, wherein the second transmission rate is 1 Mbit/sec, and the second PLCP length is computed by left shifting three bits of the byte number of the data to be transmitted.
